(19) United States
(12) Patent Application Publication
(10) Pub. No.: US 2010/0272097 A1
(43) Pub. Date: Oct. 28, 2010

(54) INTERNET PHONE TERMINAL USING WIDEBAND VOICE CODEC AND COMMUNICATION METHOD FOR INTERNET PHONE

(75) Inventors: Woon-Seob So, Daejeon-city (KR); Do-Young Kim, Daejeon-city (KR); Byung-Sun Lee, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/745,905

(22) PCT Filed: Jun. 26, 2008
(86) PCT No.: PCT/KR2008/003682

§ 371 Date: Jun. 3, 2010

(30) Foreign Application Priority Data
Dec. 6, 2007 (KR) 10-2007-0126374

(51) Int. Cl. H04L 12/66

(52) U.S. Cl. 370/352

(57) ABSTRACT

Provided are an Internet phone terminal that applies a wideband voice codec, and an Internet phone communication method. A wideband voice signal received from the Internet through a wired line or wirelessly is decoded using the wideband voice codec, and a wideband voice signal received through a microphone supporting a wideband is encoded using the wideband voice codec, so that the Internet phone terminal can provide high quality voice communication.

### TECHNICAL FIELD

The present invention relates to a portable Internet phone terminal, and more particularly, to a communication terminal that applies a wideband voice codec to improve the voice quality of telephone communication through the Internet.

This work was supported by the IT R&D program of MIC/IITA [2005-S-100-03, Wireless Broadband Internet Phone Terminal Using Wideband Voice Coded].

### BACKGROUND ART

In the conventional art, there have separately existed a wired Internet phone terminal, and a wireless Internet phone terminal using Bluetooth and a wireless local area network (LAN). Recently, an exclusive Internet phone terminal using a wireless LAN has been developed, and a dual-mode terminal that can use both a mobile network that utilizes code division multiple access (CDMA) or global system for mobile communications (GSM), and the wireless LAN is under development. However, when the wireless LAN is used, the wireless LAN can be used in only a limited area. In case of a dual-mode terminal, exchange between a mobile network and an Internet protocol (IP) network is required, and a call process is complicated.

Also, since a conventional communication terminal supports only a narrowband voice codec, an Internet phone terminal of improved quality cannot be realized. For example, a sound in the band of 6 kHz such as chirp of a cricket, not human voice cannot be heard through a general phone, an Internet phone, or a mobile phone of a narrowband currently in use.

### DISCLOSURE OF INVENTION

### Technical Problem

The present invention provides an Internet phone terminal connected to the Internet through a wired line or wirelessly and providing improved voice quality in a wideband, and a method thereof.

### Technical Solution

According to an aspect of the present invention, there is provided an Internet phone terminal comprising: an interface unit connected to the Internet through a wired line or wirelessly; a wideband voice signal input/output unit decoding a wideband voice signal received through the interface unit using a wideband voice codec, and encoding a wideband voice signal received through a microphone supporting a wideband using the wideband voice codec; and an application processor controlling the interface unit and the wideband voice signal input/output unit so that the encoded signal is transmitted to the Internet through the interface unit.

According to another aspect of the present invention, there is provided an Internet phone communication method supporting a wideband, the method comprising: receiving a wideband voice signal from the Internet through a wired line or wirelessly, or receiving a wideband voice signal through a microphone supporting a wideband; decoding the wideband voice signal received from the Internet using a wideband voice codec, and encoding the wideband voice signal received through the microphone using the wideband voice codec; and outputting the decoded signal through a speaker, and transmitting the encoded signal to the Internet.

### Advantageous Effects

According to the present invention, a wideband voice codec, a microphone, a receiver, and a speaker supporting a wideband are used to provide voice communication of high quality having increased naturality and definiteness, and various multimedia Internet services, and an application processor where indispensable functions have been integrated is used to minimize the number of parts and to facilitate design, so that a low-priced high quality terminal can be provided. Also, the Internet can be accessed wirelessly, and in the case where access to a wireless network is impossible, the Internet can be accessed through the Ethernet, so that portability increases. Also, hardware and software of various functions can be additionally mounted, so that a high quality terminal of various purposes can be provided.

### DESCRIPTION OF DRAWINGS

The above and other features and advantages of the present invention will become more apparent by describing in detail exemplary embodiments thereof with reference to the attached drawings in which:

FIG. 1 is a view illustrating a case where an Internet phone terminal according to the present invention is applied to an Ethernet environment;

FIG. 2 is a view illustrating a case where an Internet phone terminal according to the present invention is applied to a wireless Internet environment;

FIG. 3 is a view illustrating the construction of an Internet phone terminal according to an embodiment of the present invention;

FIG. 4 is a detailed view illustrating the construction of an Internet phone terminal according to an embodiment of the present invention;

FIG. 5 is a view illustrating the inner construction of an application processor of an Internet phone terminal according to an embodiment of the present invention;

FIG. 6 is a detailed view illustrating the construction of a wideband voice signal input/output unit of an Internet phone terminal that applies a wideband voice codec according to the present invention; and

FIGS. 7A and 7B are flowcharts of an Internet phone communication method supporting a wideband according to an embodiment of the present invention.

### BEST MODE

According to an aspect of the present invention, there is provided an Internet phone terminal comprising: an interface unit connected to the Internet through a wired line or wirelessly; a wideband voice signal input/output unit decoding a wideband voice signal received through the interface unit using a wideband voice codec, and encoding a wideband voice signal received through a microphone supporting a wideband using the wideband voice codec; and an application processor controlling the interface unit and the wideband voice signal input/output unit so that the encoded signal is transmitted to the Internet through the interface unit.

According to another aspect of the present invention, there is provided an Internet phone communication method supporting a wideband, the method comprising: receiving a wideband voice signal from the Internet through a wired line or wirelessly, or receiving a wideband voice signal through a microphone supporting a wideband; decoding the wideband voice signal received from the Internet using a wideband voice codec, and encoding the wideband voice signal received through the microphone using the wideband voice codec; and outputting the decoded signal through a speaker, and transmitting the encoded signal to the Internet.

### Mode for Invention

An Internet phone terminal that applies a wideband voice codec and an Internet phone communication method according to the present invention will be described in detail with reference to the accompanying drawings.

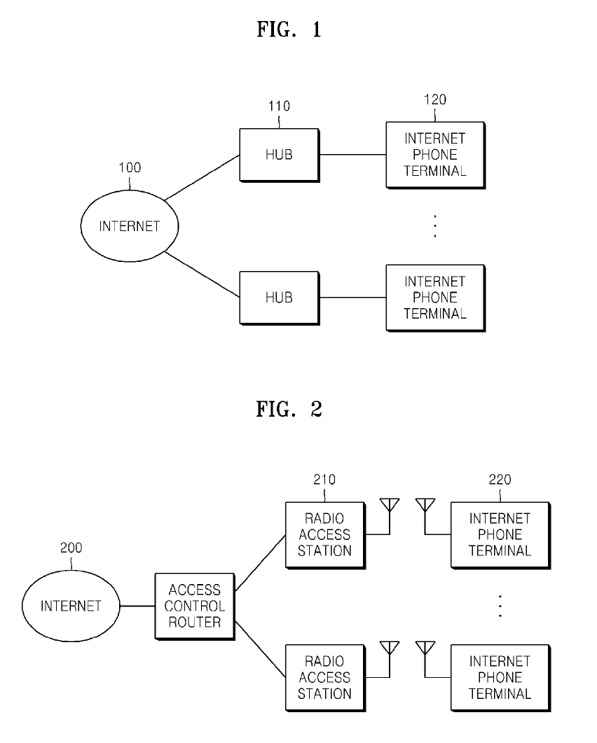

FIG. 1 is a view illustrating a case where an Internet phone terminal according to the present invention is applied to an Ethernet environment, and FIG. 2 is a view illustrating a case where an Internet phone terminal according to the present invention is applied to a wireless Internet environment.

Referring to FIGS. 1 and 2, the Internet phone terminals 120 and 220 are directly connected to an Ethernet device such as a hub 110 through a wired line, or wirelessly connected to a radio access station (RAS) 210 to provide a high quality voice communication function and an Internet access service function.

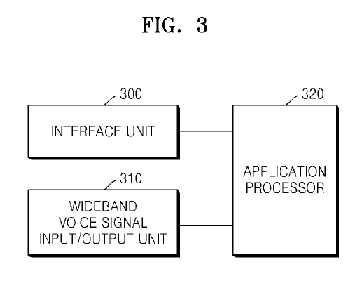

FIG. 3 is a view illustrating the construction of an Internet phone terminal according to an embodiment of the present invention.

Referring to FIG. 3, the Internet phone terminal includes an interface unit 300, a wideband voice signal input/output unit 310, and an application processor 320.

The interface unit 300 is connected to a wired/wireless communication network. The interface unit 300 includes a wireless connection means (not shown) accessing an RAS of the Internet wirelessly, and an Ethernet connection means (not shown) accessing the Internet using a wired line through the Ethernet.

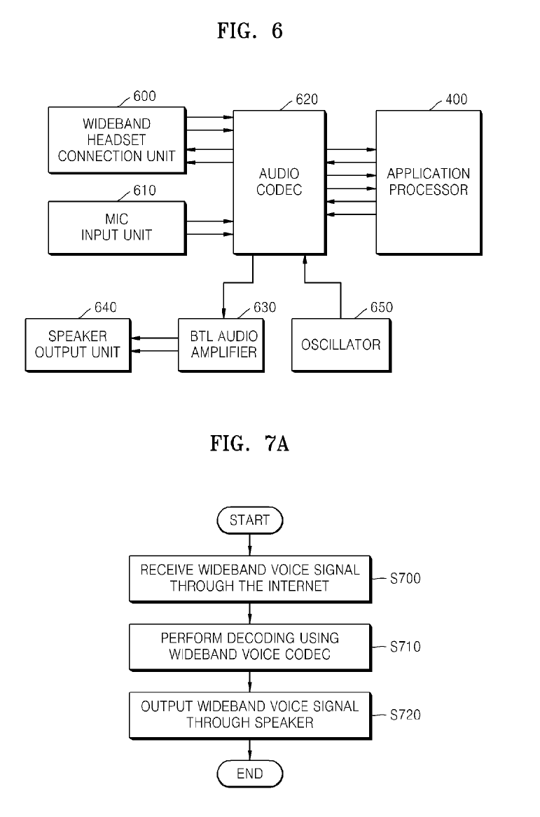

The wideband voice signal input/output unit 310 decodes a wideband voice signal received through the interface unit 300 using a wideband voice codec, and encodes a wideband voice signal received through a microphone supporting a wideband using the wideband voice codec. The detailed construction of the wideband voice signal input/output unit 310 is illustrated in FIG. 6.

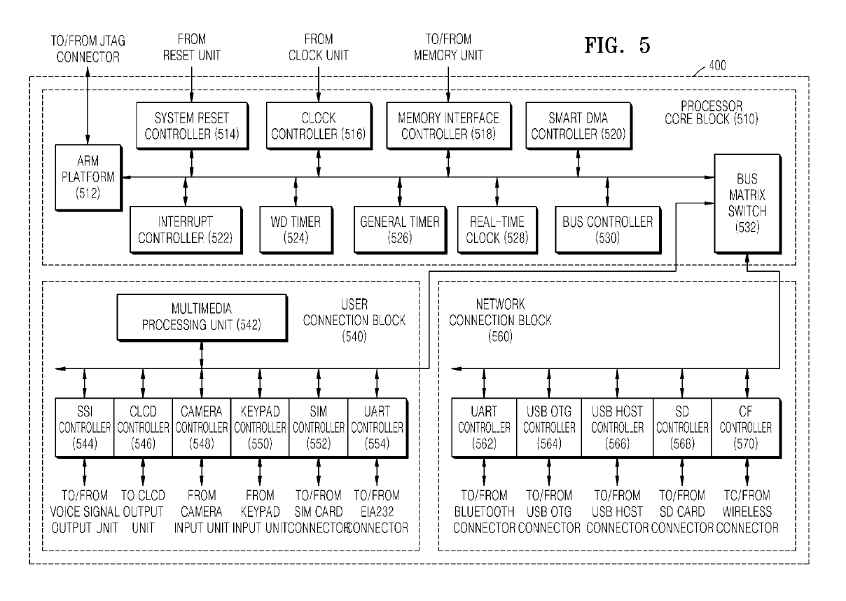

The application processor 320 controls signal input/output operations of the interface unit 300 and the wideband voice signal input/output unit 310. That is, the application processor 320 controls a signal encoded by the wideband voice signal input/output unit 310 to be transmitted to the Internet through the interface unit 300, and controls a wideband voice signal received through the interface unit 300 to be delivered to the wideband voice signal input/output unit 310. The detailed construction of the application processor 320 is illustrated in FIG. 5.

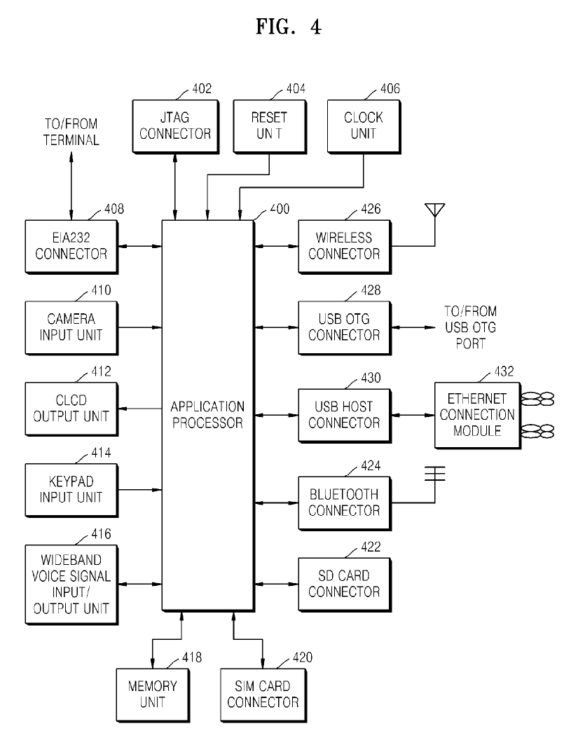

FIG. 4 is a detailed view illustrating the construction of an Internet phone terminal according to an embodiment of the present invention.

Referring to FIG. 4, the Internet phone terminal is connected to various interfaces around the application processor 400. In detail, the Internet phone terminal includes: an application processor 400; a joint test action group (JTAG) connector 402, a reset unit 404, a clock unit 406, an EIA232 connector 408, a camera input unit 410, a color liquid crystal display (CLCD) output unit 412, a keypad input unit 414, a wideband voice signal input/output unit 416, a memory unit 418, a subscriber identification module (SIM) card connector 420, a secure digital (SD) card connector 422, a Bluetooth connector 424, a wireless connector 426, a universal serial bus (USB) on the go (OTG) connector 428, and an USB host connector 430.

The JTAG connector 402 connects a JTAG controller (not shown) with the application processor 400, and can connect the application processor 400 with a debugging device such as a Multi-ICE, a RealView-ICE, and an OPENice debugging a software program operating on an ARM platform 512 (of FIG. 5) of the application processor 400. The JTAG connector 402 transmits and receives debugging information through an input data signal TDI, an output data signal TDO, a data clock signal TCK, a reset signal TRST, and a mode selection signal TSM.

The reset unit 404 supplies a power input reset signal and a switch reset signal to the application processor 400 if necessary.

The clock unit 406 supplies a clock of 26 MHz and a clock of 32.768 kHz necessary for the Internet phone terminal. These clocks are input to the application processor 400 and each clock is divided, multiplied, and supplied to each part to serve as a source of a real time clock.

The EIA232 connector 408 connects a terminal for a debugging operation with the application processor 400 through an EIA232 port. The EIA232 connector 408 includes a transceiver converting a signal level and performing a driving operation, and transmits/receives data through a transmission data signal TXD and a reception data signal RXD.

The camera input unit 410 receives an image using a color complimentary metal oxide semiconductor (CMOS) image sensor or a charged coupled device (CCD) image sensor. The camera input unit 410 uses 8-bit camera data signals CSD0 through CSD7, a camera data clock CSCLK, a camera data horizontal synchronization signal CSHSYNC, a serial control data signal SDATA, and a serial control data clock signal SCLK. The camera input unit 410 can be connected to camera lenses of various resolutions.

The CLCD output unit 412 is connected to the application processor 400 through maximum 24-bit CLCD data signals CLCD0 through CLCD23, a CLCD data clock CLCLK, a CLCD data enable signal CLDEM, a CLCD vertical synchronization signal CLVSYNC, a CLCD horizontal synchronization signal CLHSYNC to display all the states of the Internet phone terminal, messages necessary for a user, and image data. Examples of the display messages include a current state of the phone, calling and called numbers, a current time, date, day, and reception signal intensity. The application processor 400 can be programmed to add and delete various messages.

The keypad input unit 414 uses twelve basic key buttons for dialing a phone number and a special number, and sixteen function key buttons for additional service functions. The function key buttons include a menu key, an OK key, a send key, an end key, and a function setting key.

The wideband voice signal input/output unit 416 provides a wideband headset connection that can process voice signals in a wideband ranging from 50 Hz to 7 kHz, a microphone input function, and a speaker output function to perform input/output functions of improved quality voice signals.

The memory unit 418 is directly connected to the application processor 400 to store a start program or a terminal operating program, etc. The memory unit 418 includes a NOR flash read only memory (FROM) that can be accessed using a 8-bit, 16-bit, or 32-bit bus, or a NAND FROM that can be accessed using a 8-bit bus. The memory unit 418 temporarily stores user data or various application programs. The memory unit 418 can include a double data rate (DDR) synchronous dynamic random access memory (SDRAM) that can be accessed using a 16-bit or 32-bit bus, or a pseudo static random access memory (PSRAM) that can be accessed using an 8-bit, 16-bit, or 32-bit bus. Also, an external device that can be accessed in the form of a memory map can be connected.

The SIM card connector 420 is connected using a SIM card reset signal SIMRST, a SIM card data clock signal SIMCLK, a SIM card data signal SIMDATA, and a SIM card signal detecting signal SIMPD to transmit/receive data to/from a SIM card.

The SD card connector 422 is connected using SD card data signals SDDATA3 through SDDATA0, an SD card clock signal SDLCK, and an SD card write-protection signal SDWP to transmit/receive data to/from an SD card connected externally.

The Bluetooth connector 424 provides a connection function to an external Bluetooth device through wireless connection of a Bluetooth standard. The Bluetooth connector 424 includes a device converting a signal level, converting data, and performing a control. The Bluetooth connector 424 is connected using a Bluetooth transmission data signal BTXD, a Bluetooth reception data signal BRXD, a transmission request signal RTS, a transmission confirmation signal CTS, a control clock signal BTCLK, and a control data signal BTDATA to transmit/receive data.

The wireless connector 426 is connected to the application processor 400 using address signals A10 through A0, data signals D15 through D0, chip enable signals CEB1 through CEB0, an output enable signal OEB, a write enable signal WEB, a ready signal READY, a 16-bit input/output signal IOCS16B, a reset signal RESETB, an input/output unit channel ready signal IOCHRDY, a diagnosis completion signal DIAGB, an active signal ACTB, an input/output unit read signal IORD, an input/output unit write signal IOWRB, voltage sense signals VSB2 and VSB1, and card detecting signals CDB2 through CDB1 to process data for wireless transmission in the band of 2.3 GHz through the portable Internet.

The USB host connector 430 uses a USB host transceiver and is connected to the application processor 400 using input data signals VM and VP, and output data signals VMO and VPO. The USB host connector 430 is connected to a USB host port using a differential plus data signal DP and a differential minus data signal DM to transmit/receive data.

An Ethernet connection module 432 is provided in the form of a USB module, and connected to the USB host connector 430 using a differential plus data signal DP and a differential minus data signal DM. The Ethernet connection module 432 is connected to an Ethernet line using an output data plus signal TPOP, an output data minus signal TPOM, an input data plus signal TPIP, and an input data minus signal TPIM to process data so that the data is suited for a LAN protocol in its inside according to an Ethernet standard.

The USB OTG connector 428 uses an USB OTG transceiver, and is connected to the application processor 400 using input data signals OVM and OVP, output data signals OVMO and OVPO, a data enable signal DE, an interrupt signal INT, a serial data clock signal SCL, and a serial data signal SDA. The USB OTG connector 428 is connected to an USB OTG port using a differential plus data signal ODP and a differential minus data signal ODM to transmit/receive data. Unlike the USB host port, the USB OTG port supports both a device mode and a host mode. The mode is determined according to the level of an identification (ID) pin of the USB port.

The application processor 400 mounts a processor core therein, and serves as a core block connected to the respective parts to perform a protocol process according to relevant communication methods of the respective parts and a terminal function in hardware/software manners.

FIG. 5 is a view illustrating the inner construction of an application processor of an Internet phone terminal according to an embodiment of the present invention.

Referring to FIG. 5, the application processor 400 includes a processor core block 510, a user connection block 540, and a network connection block 560. The processor core block 510 includes the ARM platform 512, a system reset controller 514, a clock controller 516, a memory interface controller 518, a smart direct memory access (DMA) controller 520, an interrupt controller 522, a watchdog (WD) timer 524, a general timer 526, a real-time clock 528, a bus controller 530, and a bus matrix switch 532. The user connection block 540 includes a multimedia processing unit 542, a synchronous serial interface (SSI) controller 544, a CLCD controller 546, a camera controller 548, a keypad controller 550, a subscriber identification module (SIM) controller 552, and a universal asynchronous receiver and transmitter (UART) controller 554. The network connection block 560 includes an UART controller 562 connected to an inner bus, a USB OTG controller 564, a USB host controller 566, a secure digital (SD) controller 568, and a compact flash (CF) controller 570.

The ARM platform 512 is a 32-bit RISC microprocessor, includes instruction cache, data cash, a memory management unit (MMU), and a JTAG control function, and performs a central operation processing function.

The system reset controller 514 is connected to the reset unit 404 of FIG. 4 to initialize all the circuits of the processor in response to a reset signal input from the outside, and generates reset signals necessary for respective controllers and puts them on a bus.

The clock controller 516 is connected to the clock unit 406 of FIG. 4, and receives a signal of 26 MHz, which is a clock signal input from the outside, to generate various clocks necessary for the inside using a phase lock loop (PLL), and receives a signal of 32.768 kHz to generate a real-time clock.

The memory interface controller 518 generates control signal for writing/reading data to/from a memory device according to a timing to connect with an externally connected flash memory, a synchronous dynamic memory, or a device having the form of a memory map.

The smart DMA controller 520 generates and supplies a control signal allowing data transmission/reception between each controller and the memory to be performed fast without intervention of the processor, and can obtain a master right from the processor to transmit data.

The interrupt controller 522 processes inner and outer interrupts generated while a program is performed according to a priority.

The WD timer 524 performs a periodic watchdog timer function generating an interrupt by a predetermined period to monitor a performance procedure of the program.

The general timer 526 receives a reference clock and generates an appropriate timing signal at a time designated by the program.

The real-time clock 528 is divided using a clock of 32.768 kHz and then performs a counting operation by a unit of second using a clock of 1 Hz to calculate minute, hour, day, month, and year.

The bus controller 530 connects a data signal, an address signal, and a control signal on a multiple bus so that these signals are suited for the timing of each bus.

The bus matrix switch 532 switches between a multiple master bus and a slave bus in high speed.

The multimedia processing unit 542 encodes or decodes image data being input/output according to a pre-process, a post-process, and a standard video codec, thereby processing the image data.

The SSI controller 544 transmits/receives voice or audio pulse code modulation (PCM) data sampled by 8 kHz or 16 kHz to/from the wideband voice signal input/output unit 416 (of FIG. 4) according to a synchronization signal.

The CLCD controller 546 generates and controls CLCD data, a synchronization signal, and a clock signal to output color data information to an externally connected CLCD in high speed.

The camera controller 548 receives and processes an image source of an external CMOS sensor or CCD sensor.

The keypad controller 550 performs a scanning function of an externally connected keypad matrix, and reduces a scanning load of software using a hardware circuit configuration.

The SIM controller 552 performs a function of connecting with a SIM card externally connected and containing subscriber identification information.

The UART controller 554 controls data input/output in series, and processes data such that the data is suited for a UART protocol.

The USB OTG controller 564 allows the USB port to perform a device function or a host function depending on a mode, and processes high speed serial data according to a USB 2.0 standard to transmit/receive the data through the USB OTG port.

The USB host controller 566 processes high speed serial data according to a USB 2.0 standard to transmit/receive the data through the USB host port.

The SD controller 568 performs a function of connecting with a memory card such as an SD card or an external device.

The CF controller 570 performs a function of connecting with a memory card such as a CF card or an external device.

FIG. 6 is a detailed view illustrating the construction of a wideband voice signal input/output unit of an Internet phone terminal that applies a wideband voice codec according to the present invention.

Referring to FIG. 6, the Internet phone terminal includes a wideband headset connection unit 600, a mic input unit 610, an audio codec 620, a bridge tied logic (BTL) audio amplifier 630, a speaker output unit 640, and an oscillator 650.

The wideband headset connection unit 600 is connected to a receiver receiving voice and a microphone transmitting voice. The receiver and the microphone support a band ranging from 50 Hz to 7 kHz to allow transmission/reception voice signals to be processed in a wideband.

The mic input unit 610 receives voice and delivers the voice to the audio codec 620, and uses a microphone supporting wideband signals. In case of using electrostatic condenser type microphone, bias power is supplied to a voice signal line, which is connected with a ground signal.

The speaker output unit 640 receives a BTL output signal of the BTL audio amplifier 630 and outputs the same, and a microphone supporting wideband signals.

The speaker output unit 640 is connected using a plus output signal SPKP and a minus output signal SPKN, so that two signals merge at the speaker output unit 640 to provide twice greater power.

The audio codec 620 is connected to the application processor 400 using a transmission data signal STXD, a reception data signal SRXD, a data clock signal SCLK, a data frame synchronization signal SFS, a control clock signal ACLK, and a control data signal ADATA. The audio codec 620 converts a digital signal to an analog signal, and vice versa.

The BTL audio amplifier 630 receives an audio codec signal, and amplifies a signal using an external amplification resistor and supplies the same to drive an external speaker.

The oscillator 650 supplies signals of 11.288 MHz or 24.576 MHz necessary for the audio codec.

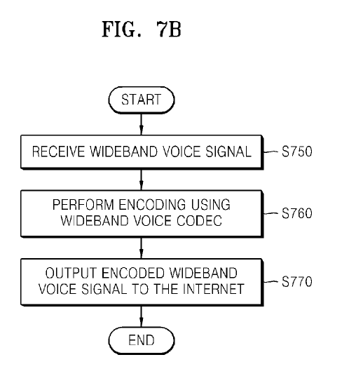

FIGS. 7A and 7B are flowcharts of an Internet phone communication method supporting a wideband according to an embodiment of the present invention.

Referring to FIG. 7A, when a terminal receives a wideband voice signal through the Internet (S700), the received wideband voice signal is decoded using a wideband voice codec (S710), and then the decoded signal is output through a speaker supporting a wideband (S720).

Referring to FIG. 7B, when the terminal receives a wideband voice signal through a microphone supporting a wideband (S750), the received wideband voice signal is encoded using a wideband voice codec (S760), and then the encoded signal is output to the Internet (S770).

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. An Internet phone terminal comprising:
an interface unit connected to the Internet through a wired line or wirelessly;
a wideband voice signal input/output unit decoding a wideband voice signal received through the interface unit using a wideband voice codec, and encoding a wideband voice signal received through a microphone supporting a wideband using the wideband voice codec; and
an application processor controlling the interface unit and the wideband voice signal input/output unit so that the encoded signal is transmitted to the Internet through the interface unit.

2. The Internet phone terminal of claim 1, wherein the interface unit comprises:
a wireless connector accessing a radio access station (RAS) of the Internet wirelessly; and
an Ethernet connector accessing the Internet using a wired line through the Ethernet.

3. The Internet phone terminal of claim 1, wherein the wideband voice signal input/output unit comprises:
a mic input unit receiving a wideband voice signal through a microphone supporting the wideband;
the wideband voice codec decoding a wideband voice signal received through the interface unit, and encoding a wideband voice signal received through the mic input unit; and
an output unit outputting the decoded signal through a speaker.

4. The Internet phone terminal of claim 3, wherein the output unit amplifies the decoded signal using a bridge tied logic (BTL) audio amplifier, and outputs the amplified signal through the speaker supporting the wideband.

5. An Internet phone communication method supporting a wideband, the method comprising:
receiving a wideband voice signal from the Internet through a wired line or wirelessly, or receiving a wideband voice signal through a microphone supporting a wideband;
decoding the wideband voice signal received from the Internet using a wideband voice codec, and encoding the wideband voice signal received through the microphone using the wideband voice codec; and
outputting the decoded signal through a speaker, and transmitting the encoded signal to the Internet.

6. The method of claim 5, wherein the outputting of the decoded signal comprises:
amplifying the decoded signal using a BTL audio amplifier; and
outputting the amplified signal through the speaker supporting the wideband.
